(19) United States
(12) Patent Application Publication
(10) Pub. No.: US 2013/0346459 A1
(43) Pub. Date: Dec. 26, 2013

(54) METHOD FOR GENERATING RANDOM NUMBERS

(71) Applicant: Eberhard BOEHL, Reutlingen (DE)

(72) Inventor: Eberhard BOEHL, Reutlingen (DE)

(73) Assignee: ROBERT BOSCH GMBH, Stuttgart (DE)

(21) Appl. No.: 13/921,615

(22) Filed: Jun. 19, 2013

(30) Foreign Application Priority Data
Jun. 20, 2012 (DE) 10 2012 210 364.3
Jun. 27, 2012 (DE) 10 2012 210 990.0

(51) Int. Cl. G06F 7/58

(52) U.S. Cl. CPC G06F 7/582
USPC 708/251

(57) ABSTRACT

A method and an assemblage for generating random numbers. In the method, at a ring oscillator that comprises an odd number of inverting elements, values are picked off at at least two sampling points, an odd number of inverting elements being present in each case between at least two directly successive sampling points.

### CROSS REFERENCE

The present application claims the benefit under 35 U.S.C. §119 of German Patent Application No. DE 102012210364.3 filed on Jun. 20, 2012, which is expressly incorporated herein by reference in its entirety, and German Patent Application No. DE 102012210990.0 filed on Jun. 27, 2012, which is expressly incorporated herein by reference in its entirety.

### FIELD

The present invention relates to a method for generating random numbers, and to an assemblage for carrying out the method.

### BACKGROUND INFORMATION

Random numbers, which are referred to as the outcome of random elements, are required for many applications. So-called “random generators” are used to generate random numbers.

Random generators are methods that supply a sequence of random numbers. A crucial criterion for random numbers is whether the outcome of the generation can be regarded as independent of previous outcomes.

Random numbers are required, for example, for cryptographic methods. These random numbers are used, for example, to generate keys for encoding methods. Such keys are subject to stringent requirements in terms of randomness properties. Pseudo-random number generators (PRNGs), represented, e.g., by a linear feedback shift register (LFRS), are therefore not suitable for this purpose. Only a true random number generator (TRNG) meets the applicable requirements. These utilize natural noise processes in order to obtain an unpredictable outcome. Noise generators that utilize the thermal noise of resistors or semiconductors, or the shot noise at potential barriers, for example at p-n transitions, are usual. A further possibility is to utilize the radioactive decay of isotopes.

While the “classic” methods use analog elements, such as, e.g., resistors, as noise sources, digital elements such as, for example, inverters, have often been used in the recent past. These have the advantage of lesser complexity in terms of circuit layout, since they are available as standard elements.

Conventionally, for example, ring oscillators are used, which represent an electronic oscillator circuit. With these, an odd number of inverters is interconnected into a ring, producing an oscillation having a natural frequency. The natural frequency depends on: the number of inverters in the ring; the properties of the inverters; the interconnection conditions, i.e., lead capacitances; the operating voltage; and the temperature. The noise of the inverters results in a random phase shift with respect to the ideal oscillator frequency, which is used as a random process for the TRNG. It is noteworthy that ring oscillators oscillate independently, and do not require external components such as, for example, capacitors or coils.

One problem in terms of the utilization of randomness occurs because the ring oscillator must be sampled as close as possible to an expected ideal edge so that a random sample value is obtained. The publication of Bock, H., Bucci, M., Luzzi, R.: An Offset-Compensated Oscillator-Based Random Bit Source for Security Applications, CHES 2005, indicates a possibility for always sampling in the vicinity of an oscillator edge, by controlled shifting of the sampling point in time.

European Patent No. EP 1 686 458 B1 describes a method for generating random numbers with the aid of a ring oscillator, in which a first and a second signal are made available, the first signal being sampled in a manner triggered by the second signal. In the method described, a ring oscillator is repeatedly sampled, in which context only non-inverting delays, i.e., an even number of inverters as delay elements, are always used. The oscillator ring is always sampled, simultaneously or with a mutual delay, after an even number of inverters beginning from a starting point. Shifting of the sampling time can thereby be omitted; instead, the repeatedly sampled signals are evaluated.

A further possibility involves the use of multiple ring oscillators, as explained e.g., in the publication Sunar, B. et al.: A Provable Secure True Random Number Generator with Built In Tolerance to Active Attacks, IEEE Trans. on Computers, 1/2007. Here multiple sample values from different ring oscillators are combined with one another and evaluated. A good random value can be achieved in this manner if the corresponding prerequisites in terms of implementation are met. Unfortunately, the necessary XOR instruction cannot operate at the required high frequency, and because of substrate coupling on the chip the multiple ring oscillators are not independent of one another; they potentially correlate in terms of frequency (which, if applicable, is harmless), but also in terms of phase, with the result that it may not be possible to achieve the desired quality of the random numbers that are generated.

It should be noted that the complexities of conventional circuits are very substantial. Either a structure for shifting the sampling point in time must be used, which structure can moreover also be susceptible to attacks and make the generated bits dependent on one another; or a very large number of sample values must be processed in parallel. Additional delay elements may also be necessary. An additional, slow ring oscillator is furthermore required.

### SUMMARY

An example method in accordance with the present invention allows random numbers to be generated using a single ring oscillator. A conventional slow ring oscillator for sampling, can be omitted. There is also no need for additional delay elements.

The example method makes possible on-line error detection and generation of a warning if the ring oscillator is not active or is correlated with the clock cycle of the sampling frequency. With monitoring of the warnings, after a specific number of warnings the frequency of the oscillator can be actively influenced, and/or after a further number of warnings an error message can also be outputted.

For monitoring, values at sampling points at one point in time, i.e., the fact that the values are present at the sampling points at one point in time, can be compared with at least one predetermined pattern, for example (0, 0, 0) or (1, 1, 1).

Chronologically successive sample values can be compared with one another in order to detect a relationship of those sample values with one another. This need not mean that an error exists. An error is assumed only when a specific number is exceeded.

The assemblage for carrying out the method encompasses, in an embodiment, a ring oscillator that is made up of a fed-back series circuit of multiple inverting elements and that oscillates at a first frequency. Sampling occurs synchronously with a sampling signal. The frequency of the sampling signal can be generated from a further signal that oscillates at a second frequency, or can be derived from the system clock, i.e., from a clock cycle that is used for further circuit elements, e.g., on the chip. The outputs of at least two of the inverting elements of the ring oscillator are stored as a multiple-bit sample value. At least two of these multiple-bit sample values from different sampling times are stored. From a comparison of the instantaneous multiple-bit sample value with another stored multiple-bit sample value, a first output signal is generated and is evaluated in an evaluation circuit.

Provision can be made that the first output signal is generated when the two multiple-bit sample values are identical. Provision can further be made that the evaluation circuit is a counter, said counter being incremented at each activity of the first output signal, i.e., when the value of the output signal at a specific predetermined point in time is “high,” and the counter is reset to a value of zero at each non-activity of the first output signal, i.e., when the value of the output signal at the aforesaid specific predetermined point in time is “low”; and as a function of one or more state values of the counter, output signals are generated which influence the frequency of the ring oscillator or indicate an error.

An error can moreover be indicated on a second output signal if at least one multiple-bit sample value corresponds to at least one predetermined bit pattern.

Further advantages and embodiments of the present invention are evident from the description below and the figures.

It is understood that the features described above and those described below are usable not only in the respective combination indicated, but also in other combinations or in isolation, without departing from the scope of the present invention.

### BRIEF DESCRIPTION OF THE DRAWINGS

FIG. 1 shows an embodiment of a ring oscillator for carrying out an example method in accordance with the present invention.

FIG. 2 shows a possibility for error detection.

FIG. 3 shows a further possibility for error detection.

FIG. 4 shows an event counter.

FIG. 5 shows a ring oscillator with power supply.

FIG. 6 shows a frequency divider.

FIG. 7 shows a further assemblage for carrying out the example method described.

FIG. 8 shows profiles of sample clocks.

### DETAILED DESCRIPTION OF EXAMPLE EMBODIMENTS

The present invention is depicted schematically in the figures on the basis of exemplifying embodiments, and will be described in detail below with reference to the figures.

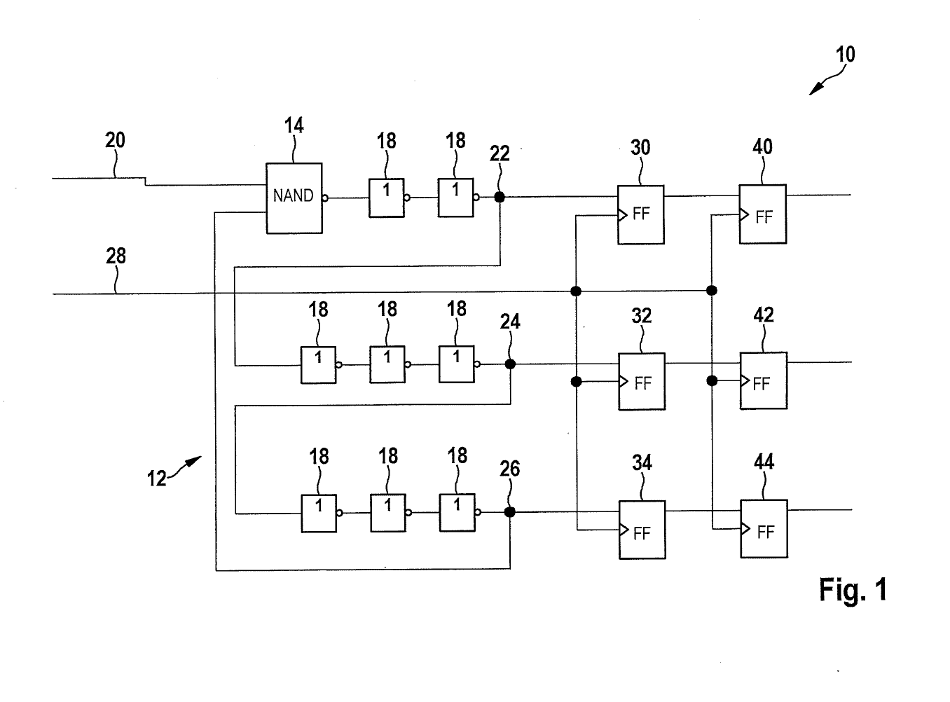

FIG. 1 shows an embodiment of an assemblage for carrying out the example method described, which assemblage is labeled in its entirety with the reference number 10. This assemblage 10 encompasses a ring oscillator 12 that has a NAND member 14 and eight inverters 18, and thus nine inverting elements. The ring oscillator thus possesses an odd number of inverting elements.

Ring oscillator 12 can be started and stopped with a first input 20. The depiction further shows a first sampling point 22, a second sampling point 24, and a third sampling point 26. The sampling rate is predetermined via a second input 28. This means that beginning from first sampling point 22, a sampling action always occurs after an odd number of inverting elements. First sampling point 22 is sampled with a first flip-flop 30, the result being sample value s0. Second sampling point 24 is sampled with a second flip-flop 32, the result being sample value s1. Third sampling point 26 is sampled with a third flip-flop 34, the result being sample value s2. Associated with first flip-flop 30 is a further, fourth flip-flop 40. This latter performs a memory function and outputs the value s0′ which precedes the value s0 in time, i.e., s0 and s0′ are chronologically successive sample values of first sampling point 22. Correspondingly, second flip-flop 32 has associated with it a fifth flip-flop 42 that outputs s1′, and third flip-flop 34 has associated with it a sixth flip-flop 44 that outputs s2′.

Ring oscillator 12 can thus in principle be constructed from, for example, nine inverters 14. One of these inverters 14 can be replaced by NAND element 14 in order to continue ring oscillator 12. Alternatively, this NAND element 14 can also be replaced by a NOR element.

In the example embodiment shown, the values of ring oscillator 12 are stored isochronously at three different inverters, each in one flip-flop (FF) 30, 32, 34. These pickoffs are intended to be distributed as equally as possible over the elements of ring oscillator 12. For the case of nine inverting stages in ring oscillator 12, a pickoff or a sampling point 22, 24, 26 is therefore provided after each three inverting elements.

The number of inverter stages in ring oscillator 12 determines the frequency of the oscillator, and should therefore be selected so that the flip-flops can store the respective signal value. If the highest possible oscillator frequency is used, the probability of being in the vicinity of an edge upon sampling is higher. The number of inverters selected in the oscillator ring is therefore as small as possible, but still large enough that the flip-flops are capable of working for the frequency that is attained. For a 180-nm technology, a frequency of approx. 1 GHz for ring oscillator 12 having nine inverters 18 has been determined on a simulated basis. The flip-flops can store the signal values at this frequency, as has been demonstrated by simulation.

Storage of the sample values after each three inverter stages, with one inversion of the signal in each case, differs from the conventional approach, in which a delay of two inverter stages, i.e. without inversion of the delayed signal, is always required. In addition, successive sample values are not compared with one another therein.

The example method presented can be carried out using a ring oscillator that has an odd number of inverting elements, values being picked off at at least two sampling points of the ring oscillator, and an odd number of inverting elements being present in each case between at least two directly successive sampling points.

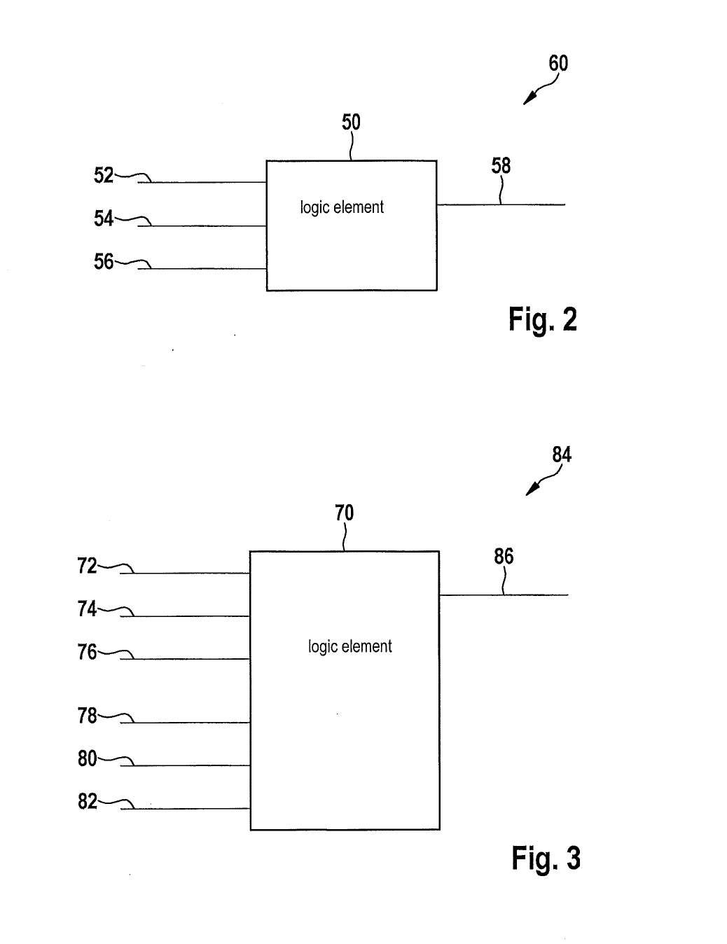

FIG. 2 shows the possibility of identifying an error. The variables s0 52, s1 54, s2 56 enter a logic element 50. If s0=s1=s2, an error signal 58 is outputted.

It can be shown that only one signal at a time of these three outputs can contain a random value. It is furthermore practically impossible, in the absence of an error, for all three sample values s0, s1, s2 to have the same logical value. Logic element 50, which can also be referred to as checker 60, checks whether signals s0=s1=s2, and then, if applicable, outputs the “error” signal 58, where “error”=(s0̂s1̂s2) v(/s0̂/s1̂/s2), where “̂”=conjunction, “v”=disjunction, and “/”=inversion.

The “error” signal is, for example “1” if one of the three flip-flops having the outputs s0, s1, or s2 has an error. This error can be a permanent error due to a defect, or can have been brought about by an error attack. An error attack represents a deliberate influence on the TRNG that can be brought about, for example, by electric fields, alpha particles, neutrons, or by laser radiation. It may be important to detect such attacks and react to them.

FIG. 3 shows a further possibility for error detection using a logic element 70 having the inputs s0 72, s1 74, s2 76, s0′ 78, s1′ 80, and s2′ 82. A warning signal 86 can be outputted as an output. This possibility is also referred to as warning generator 84.

What is taken into consideration here is that in accordance with FIG. 1, each time a three-bit sample value s0, s1, and s2 is stored, the previous values are stored in three further FFs s0′, s1′, and s2′. A warning is generated in the warning generator if the three most recently stored bit values are identical to the three previously stored bit values:

“warning”=(s0≡s0′)̂(s1≡s1′)̂(s2≡s2′), where “̂” conjunction and “≡” equivalence (XNOR).

A warning is outputted, for example, when the ring oscillator is not active, for example because the start signal=0 or the oscillator is not oscillating for other reasons.

A warning is also outputted when the oscillator frequency is, for example, an integral multiple of the sampling frequency. The oscillator is then always sampled in the same state. The correlation between the two frequencies can be random, can be caused by coupling effects between the oscillator frequency and the system clock (see discussion below), or can be the result of a deliberate influence (frequency injection attack). Such an attack, or the inadvertent coupling, must also be discovered and, if possible, prevented or counteracted. Actions for this are indicated. If exactly one bit in the three sampled bits is different, then, for example, at least one random value exists at that corresponding sample value, since sampling occurs in the vicinity of an edge.

A warning can, however, also be generated when the ratio of the oscillator frequency to the sampling frequency differs only slightly from an integral value. A warning can then be outputted repeatedly even though no correlation exists between the two frequencies. A presumption of correlation between these two frequencies is therefore probable only when a warning has been outputted repeatedly in succession, typically in excess of a predetermined number.

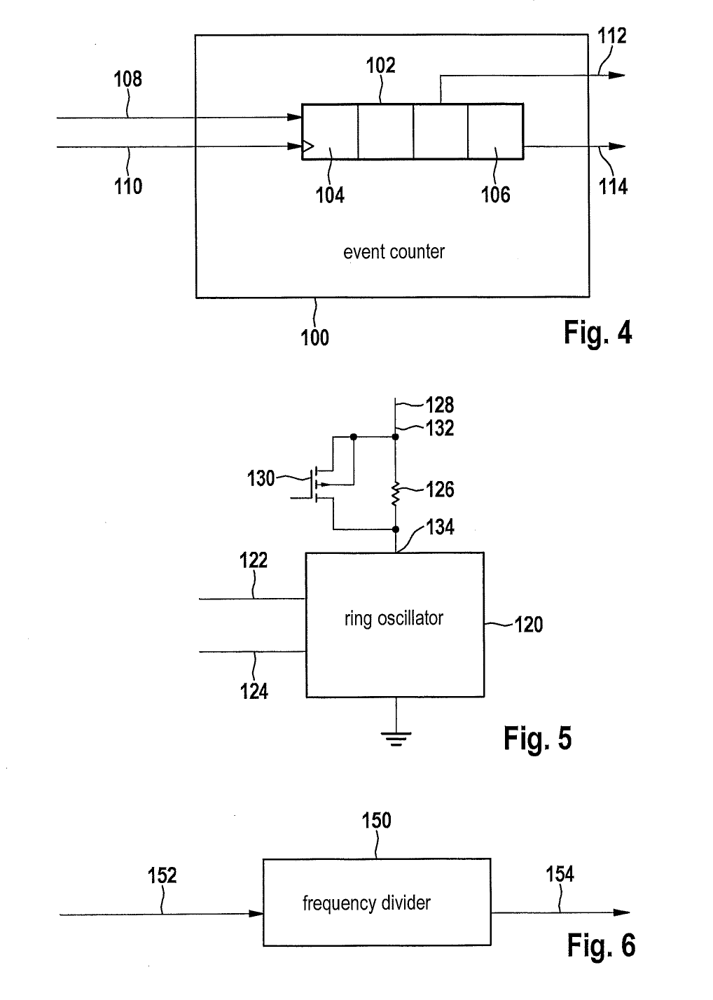

A correlation between oscillator frequency and sampling frequency can have serious consequences. For example, if the sampling frequency was produced from the system clock by integral division, and if the system clock is used on the chip for switching operations, such a switching operation can generate periodic substrate currents that can influence the oscillator frequency. In the worst case the ring oscillator correlates with the system clock, with the result that all noise effects, i.e., jitter and therefore randomness, can be lost. It is therefore important to count the warnings in an event counter according to FIG. 4.

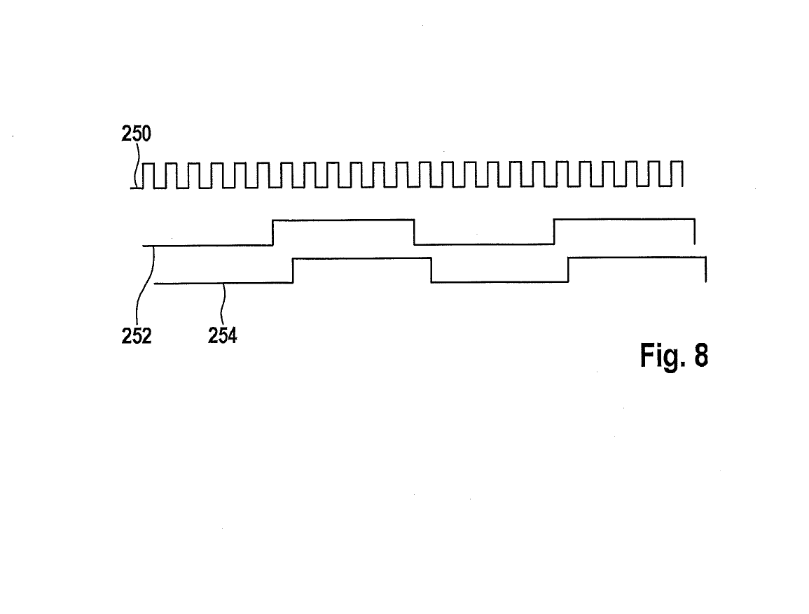

FIG. 4 shows a so-called event counter 100 that encompasses a register 102 in which bits are stored. In the depiction, LSB 104 and MSB 106 are indicated. A first input 108 inputs the warning signal; a second input 110 inputs a sample clock sample_clock_dly. The sample clock used here is a clock that is obtained from sample_clock by delaying, for example by an amount equal to one system clock cycle. This is depicted in further detail in FIG. 8.

A first output 112 outputs a signal that can be used to modify the oscillator frequency once a first threshold value of the number of successive warnings is reached. A second output 114 outputs an error signal that is generated when the number of successive warnings exceeds a second threshold value.

Event counter 100 is reset at a value “warning=0,” and incremented at “warning=1.” If event counter 100 reaches, for example, a value of 16, and thus a second threshold value, an error signal is then outputted. It is furthermore proposed that, for example, the frequency of the oscillator is already influenced at a value of 8 (a first threshold value) of event counter 100, in order to avoid a possible correlation. Such an influence on the frequency of the oscillator can be effected, for example, by switching in or out additional capacitances at at least one inverter of the ring oscillator, or by varying the supply voltage of the ring oscillator. This type of variation of the supply voltage can be accomplished, for example, by switching on, switching off, or generally varying a resistor in the supply voltage lead of the ring oscillator.

FIG. 5 shows this possibility, the switch being embodied as a p-channel transistor. The depiction shows a ring oscillator 120 having a first input 122 for starting and a second input 124 for the sample clock. A resistor 126 in a power supply lead 128 can be bypassed using a p-channel transistor 130. A general power supply 132, and a power supply 134 of ring oscillator 120, are therefore present. The depiction illustrates the possibility of influencing the oscillator frequency by way of the bypassed resistor 126 in supply lead 128 of ring oscillator 120, in this case switched through p-channel transistor 130. Any other switch is, however, also possible. Also possible are multiple switches for different first threshold values.

If the result of this action is the warning “warning=0,” the event counter is reset. In the contrary case, the event counter is further incremented until an error is outputted. The error can prevent the TRNG from continuing to output values, or can in fact stop the oscillator. Multiple event-counter values, at which different actions may be taken, are conceivable.

In many standard approaches, an attempt is made to counteract a correlation between the oscillator frequency and sampling frequency by the fact that the sampling frequency is generated by a further ring oscillator, typically at a lower frequency. It is not thereby possible, however, to prevent both the fast ring oscillator and the slow ring oscillator from correlating with the system clock. The slow ring oscillator can therefore be omitted. The sample clock can therefore also be obtained from the system clock, using a frequency divider, if a correlation can be identified and can be influenced, for example by modifying the oscillator frequency. The frequency divider according to FIG. 6, for obtaining the sample clock from the system clock, should have for that purpose at least one integral division value. Direct correlations of the system clock can then be discovered at the same oscillator inverter stages using the method described above.

Also possible, however, is a correlation in which one system clock edge influences a first inverter stage, and a further same-direction system clock edge influences a second inverter stage. This can occur, for example, because the system clock acts, e.g., via substrate currents on the entire oscillator, but only those inverters at which a change in state is currently occurring are particularly sensitive to coupling effects. It may therefore happen that the above-described position of the second inverter is disposed with an offset of two inverters from the first inverter stage. A further same-direction system clock edge can then influence a third inverter stage that is offset four positions from the first inverter stage, and so forth. The correlating frequency could then deviate by 2/9, 4/9, etc. from the oscillator frequency.

Every ninth same-direction system edge would then again influence the same position in the oscillator. The system clock would then influence exactly the same position in the oscillator for every ninth sample value (s0, s1, and s2). Every ninth sampling action would then therefore again be referred to the same condition in the oscillator, i.e., the same signal levels would be present in the oscillator, and thus the same sample values (s0, s1, and s2) would be present, if sampling were performed using the system clock or an integrally divided system clock (see FIG. 5).

If the division value of the frequency divider is a multiple of 9, however, then in this case as well, warnings can already be generated between two successive sample values. The same method for detecting correlations can therefore be used for this instance as well. It is therefore very useful if a multiple of 9, or a multiple of the number of inverting elements in the ring oscillator, is selected for the division ratio.

This eliminates the need to store a large number of sample values for the detection of correlations; this is illustrated in FIG. 6. FIG. 6 shows a frequency divider 150 having an input 152 for the system clock or for the so-called “slow” oscillator clock, and an output 154 for the sample clock, where n=number of inversions in the fast oscillator and m=number of inversions in the slow oscillator. “LCM” refers to the least common multiple. The relationship is:

Division ratio: i*n or i*LCM(n,m)

Consideration can be limited to storage two times, as in FIG. 1, and warnings can thus also be generated in the above-described cases in accordance with FIG. 3.

In a further possible case, one edge of the system clock could influence a first inverter stage, and an oppositely directed edge of the system clock could influence a second inverter stage that is disposed in the ring oscillator with an offset of only one position from the first inverter stage. If the working cycle of the system clock is 50%, i.e., the low phase and high phase of the system clock are of equal length, a correlation can be caused by this as well: a positive edge influences the first inverter of the ring oscillator, and a negative edge of the system clock influences the next inverter. After every nine same-direction edges, or a total of 18 edges, however, here as well the same situation is arrived at as at the beginning. If the division value of the frequency divider corresponds to a multiple of 9, however, here again the correlation is detected using the same method according to FIG. 3. An implementation of the frequency divider is proposed in FIG. 6.

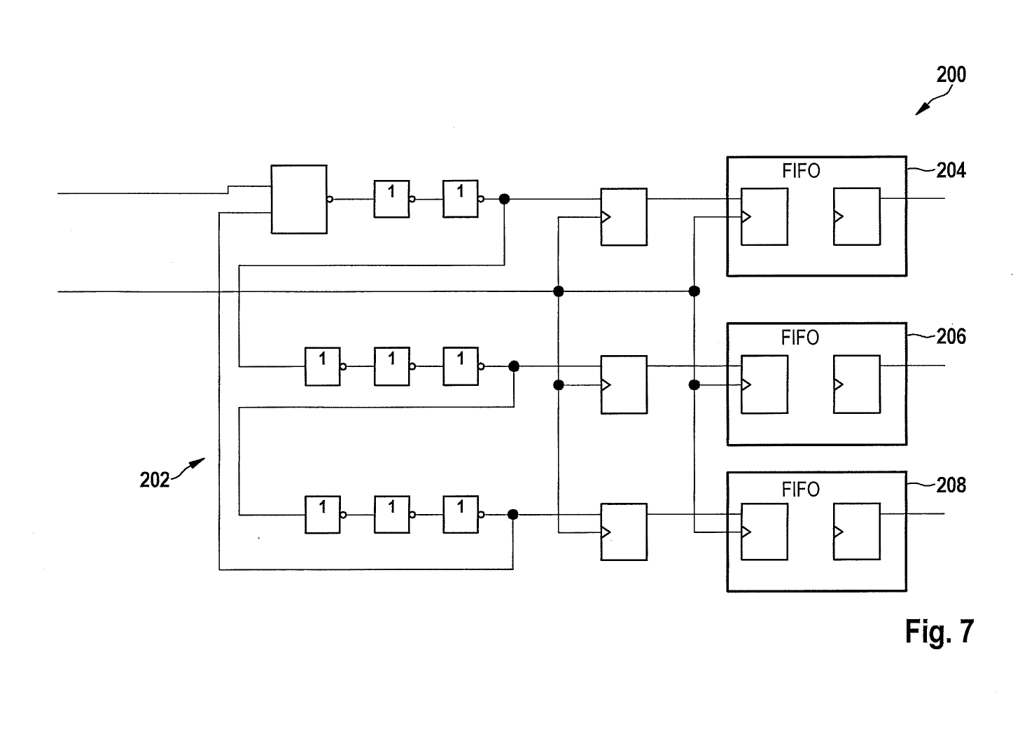

FIG. 7 shows an assemblage 200 having a ring oscillator 202 having FIFOs 204, 206, and 208, when the clock divider cannot be selected, in accordance with FIG. 6, to have a division ratio equal to a multiple of 9 or to the number of inverting elements in the ring oscillator in FIG. 1. In this case it is necessary for more than just two sample values to be stored, and for every ninth sample value always to be compared with one another. A FIFO (first-in first-out memory) having a depth of 9 is used for this purpose. This memory has the property that whenever a memory value is stored, output of the value nine storage events earlier occurs. If this value outputted from the FIFO is compared with the instantaneous sample value, it is thus possible to generate a warning (as described previously) according to FIG. 3 if the output values of FIFOs 204, 206, and 208 according to FIG. 7 are used instead of the sample values 40, 42, and 44 according to FIG. 1.

In a further embodiment of the example shown, the depth d of the FIFO and a division value w of the clock divider can also be used in such a way that w*d corresponds to the number of inverting elements, and the division ratio of the clock divider according to FIG. 6 is divisible by w.

FIG. 8 shows profiles of clock cycles, namely a system clock 250, a sample clock (sample_clock) 252, and a delayed sample clock (sample_clock_dly) 254. FIG. 8 thus illustrates examples of properties of sample_clock_dly with reference to the sample clock and system clock. The delayed sample clock can be obtained from the sample clock, for example, by feeding the sample clock into a flip-flop that is timed using the system clock.

The following general considerations apply: The instantaneous values of the ring oscillator should preferably be stored simultaneously in the flip-flops at at least three locations. The positions of the corresponding inverters of the ring oscillator at which sampling occurs should be distributed as uniformly as possible over the ring oscillator; and if possible, an odd number of inverting stages should be located between two adjacent sampling positions. The sampled values are compared with predetermined patterns, for example (0, 0, 0) or (1, 1, 1). In a further embodiment, sampling can also occur after each inverting element. In an embodiment, sampling of the ring oscillator occurs at a frequency that is obtained from the system clock by frequency division, and the division ratio used as a basis corresponds to an integer that is a multiple of the number of inverter stages (including the NAND) of the oscillator.

Alternatively, the sample clock can also be generated from a slow ring oscillator by frequency division. The division ratio should be integral, and should be a multiple of the lowest common multiple (LCM) of the number of inverting stages in the fast and in the slow oscillator. If such a division ratio is not possible, for example because it is too large, a smaller division ratio can also be selected. In order to discover the above-described correlations at various positions, the data must be buffered, e.g., in a first-in first-out memory, as described above.

A factor x not considered in the division ratio then indicates that every x-th sample should be compared with one another in order to discover all the above-described correlations. The

FIFO should then possess a depth of x memory elements, i.e., an input value into the FIFO appears at the output of the FIFO after x clock cycles.

What is claimed is:

1. A method for generating random numbers, comprising:
picking off values at a ring oscillator, that has an odd number of inverting elements, at at least two sampling points, an odd number of inverting elements being present in each case between at least two directly successive sampling points.

2. The method as recited in claim 1, wherein values are picked off at at least three sampling points, an odd number of inverting elements being present in each case at least twice between two directly successive sampling points.

3. The method as recited in claim 1, in which picking off always occurs after an odd number of inverting elements.

4. The method as recited in claim 1, wherein the picking off occurs isochronously at all sampling points, synchronously with at least one sampling signal.

5. The method as recited in claim 1, wherein values at the sampling points at one point in time are compared with at least one predetermined pattern.

6. The method as recited in claim 1, wherein chronologically successive sample values at a sampling point are compared with one another in order to detect a relationship of those sample values with one another.

7. The method as recited in claim 5, further comprising:
outputting a warning signal upon detection of a predetermined pattern.

8. The method as recited in claim 6, further comprising:
outputting a warning signal upon detection of a predetermined relationship.

9. An assemblage for generating random numbers, comprising:
a ring oscillator that has an odd number of inverting elements, at least two sampling points for picking off values being provided, and an odd number of inverting elements being provided in each case between at least two directly successive sampling points.

10. The assemblage as recited in claim 9, wherein at least three sampling points for picking off values being provided, and an odd number of inverting elements being provided in each case at least twice between two directly successive sampling points.

11. The assemblage as recited in claim 9, wherein one of the inverting elements is a NAND member.

12. The assemblage as recited in claim 9, wherein flip-flops are provided for picking off the values.

13. The assemblage as recited in claim 9, in which an event counter is additionally provided.
